(19) United States
(12) Patent Application Publication
(10) Pub. No.: US 2005/0106537 A1
(43) Pub. Date: May 19, 2005

(54) Dynamic tactile and low vision fonts

(76) Inventor: Andrew Chepaitis, New York City, NY (US)

Correspondence Address: JACOBSON HOLMAN PLLC, 400 SEVENTH STREET N.W., SUITE 600, WASHINGTON, DC, 20004, US

(21) Appl. No.: 10/511,036

(22) PCT Filed: Apr. 17, 2003
(86) PCT No.: PCT/US03/11789

Related U.S. Application Data
(60) Provisional application No. 60/373,376, filed on Apr. 18, 2002.

(51) Int. Cl. G09B 21/00

(52) U.S. Cl. 434/114

(57) ABSTRACT

A dynamic tactile code in which embossed alphabetic symbols represent the letters of the conventional Roman alphabet and embossed numeric symbols represent the conventional Arabic numerals. The alphabetic symbols are divided into four regions, the alphabetic symbols in the first and third regions being denoted by a circular frame, and the alphabetic symbols in the second and fourth regions being surrounded by a square frame. At least some of the alphabetic symbols embody at least a physical association of their corresponding letter of the Roman alphabet. Uppercase symbols differentiate from the lowercase symbols by the placement of a dot centrally located above the lowercase symbol frame. The numeric symbols are denoted by a diamond-shaped frame. Certain essential attributes of the font remain constant while other attributes change as the font's size is changed. In particular, (1) inter-symbol spacing changes by a non-constant ratio; (2) line width changes by a non-constant ratio; (3) symbol element ratios changes by a non-constant ratio; (4) symbol element location changes by non-constant ratios; (5) symbol shape changes from font size to font size; (6) symbol elements can be present at some sizes and not present at other sizes or the element sizes can vary in different, non-constant proportions to each other; and (7) at one size, the symbol elements remain fixed or vary based on their location on a visual display, and symbols displayed in the middle of the display look different than when they are displayed at the side of the display.

### CROSS-REFERENCE TO RELATED APPLICATIONS

The present patent application is a nationalization of International application No. PCT/US2003/11789, filed Apr. 17, 2003, published in English, which is based on, and claims priority from U.S. provisional Application No. 60/373,376, filed Apr. 18, 2002, both of which are incorporated herein by reference in their entireties.

### COPYRIGHTED MATERIAL

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to tactile and low vision fonts for use in reading materials for the blind and visually impaired, and particularly to such fonts that are dynamic, such that the symbols of the font change shape according to font size.

### BACKGROUND OF THE INVENTION

Tactile alphanumeric fonts for the visually impaired and blind are known from, for example, U.S. Pat. No. D321,903 and U.S. Pat. No. 4,737,108, both to Elia Chepaitis. The fonts disclosed in U.S. Pat. No. D321,903 and U.S. Pat. No. 4,737,108 are collectively known as the ELIA™ font, which is owned and marketed by ELIA Life Technology.

U.S. Pat. No. 4,737,108 is specifically directed to embossed symbols that represent the letters of the alphabet and the Arabic numerals 0-9, which can be traced with the fingertips. The fonts disclosed in U.S. Pat. No. D321,903 and U.S. Pat. No. 4,737,108 were intended to provide a system of embossed symbols that offered easily learned and readable letters and numbers, building on knowledge and skills that many visually impaired and blind people have already acquired; and to provide a system of embossed symbols that resembled the letters of the conventional Roman alphabet and the conventional Arabic numerals.

The prior art ELIA™ font was designed (in part) according to human factors engineering principles. They included, but were not limited to, design around potential users' existing knowledge, ease of differentiation between the end of one symbol and the beginning of the next, and interfacing neatly with existing technology. The prior art ELIA™ font also was designed to have a large amount of redundancy, in sharp contrast to Braille, which has been described as “inherently confusing (because it is) . . . non-redundant”.

All of the alphabetic and numeric symbols of the prior art ELIA™ font comprise at least one component, a frame. The alphabetic symbols of prior art ELIA™ font is divided into four regions, the first and third regions having circular frames and the second and fourth regions having square frames. Thus, when a reader encounters a circle, for example, he or she knows that he or she is dealing with a letter in the first or third region. All of the numeric symbols have diamond-shaped frames. The frames therefore serve as the primary key to direct the reader to a limited number of candidates, to make deciphering as swift and easy as possible. All of the alphabetic and numeric symbols except the “L” and “O” alphabetic symbols and the “0” numeric symbols also have at least one second component, a line, curve, or dot within their interior. Each of the alphabetic symbols embodies at least a physical association, and in some cases also a logical association, with its corresponding capital letter of the Roman alphabet. The most easily traced symbols are reserved for the vowels and those letters that are used most often.

Braille, the raised Roman alphabet, and other alphabets such as the Fishburne alphabet and the Moon alphabet (used in the UK, designed in 1845), do not have all of the features of the prior art ELIA™ font. Of the mentioned alphabets, only the Moon alphabet resembles some of the Roman alphabet. Instruction in the Moon alphabet is not available on a nationwide basis in the US. Fewer visually impaired use the Moon and the Fishburne alphabets than use Braille (in the US). None of these alphabets utilizes a frame for easy differentiation and all were limited by the technology available at their time of invention. Braille was efficient and became the standard because in 1826 punching bumps in a piece of paper was a very cost effective and practical way for the blind to produce their own texts. Moon was efficient because it used 14 copper bands that could be pressed into paper to produce tactile symbols, many of which are similar to the Roman alphabet letters. However, Moon's users had difficulty producing their own texts and were therefore dependent on others to assist them. Fishburne was designed to utilize users deductive reasoning skills (it is divided into simple shapes that are organized according to their order in the alphabet).

In spite of its superiority to prior art alphabets for the blind and visually impaired, the prior art ELIA™ font is not without its deficiencies. In studies conducted using the prior art ELIA™ font, it was found that element spacing and inter-symbol spacing are optimally readable at only one font size or within a small range of font sizes; and that font users would need a number of similar computer fonts (i.e., variations of the prior art ELIA™ font) to produce readable tactile text at different font sizes and would need to adjust those fonts' software in order to present a font with distinguishable font spacing and line widths. These adjustments could still result in inadequate spacing and line width adjustments because as the prior art ELIA™ font are reduced in size, their elements and spacing (interiors and inter-symbol) change proportionally to their size. The constant rates with which certain line width and spacing ratios change make them difficult to read at different font sizes.

Also, the prior art ELIA™ tactile font uses only one color. The studies conducted using the ELIA™ font reveal that the single color makes text printed in the ELIA™ font unnecessarily difficult for sighted readers to interpret.

The prior art ELIA™ font uses frames that are either circles, squares or diamonds. The studies conducted using the ELIA™ font reveal that these frame shapes are not optimal for some letters. Further, the studies indicate that some of the interiors of the symbols of the ELIA™ font, while readable, are not optimal.

Further, when printing a document using the prior art ELIA™ font, users must adjust the line width, letter spacing, and element/line location in order for the print to be legible in different font sizes. Some necessary changes are not possible within one computer font file. As a result, tactile readers find it difficult to move between font sizes.

It is to the solution of these and other problems that the present invention is directed.

### BRIEF SUMMARY OF THE INVENTION

It is accordingly and object of the present invention to provide a dynamic tactile font that enables persons with reduced visual and/or tactile acuity to read fonts with greater accuracy and speed.

It is another object of the present invention to provide a dynamic tactile font that enables persons with reduced visual and/or tactile acuity to produce text with less effort.

It is still another object of the present invention to provide a dynamic tactile font that can take the place of multiple variations of the prior art ELIA™ font.

It is still another object of the present invention to provide a dynamic tactile font that will adjust the letter line width, element spacing and inter-symbol spacing of the alphabetic symbols automatically, rather than adjusting present software settings so that the alphabetic symbols of variations of the font are optimally spaced for different font sizes.

It is still another object of the present invention to enable font users to use one font and scale a font without the need for complicated adjustments within their software, to eliminate the need for multiple fonts for visually impaired readers, and to allow them to move more easily between font sizes.

It is still another object of the present invention to provide a dynamic tactile font that has more distinguishable elements (frames, interiors, etc.) that address the needs of both the disabled readers and their sighted caregivers or teachers.

These and other objects of the invention are achieved by the provision of a dynamic tactile code for use by visually impaired and blind persons comprising embossed alphabetic symbols representing the letters of the conventional Roman alphabet and embossed numeral symbols representing the conventional Arabic numerals. The alphabetic symbols are divided into first, second, third, and fourth regions or groups, the alphabetic symbols in the first and third regions or groups being denoted by a circular frame, and the alphabetic symbols in the second and fourth regions being surrounded by a square frame. At least some of the alphabetic symbols embody at least a physical association, such as a dominant characteristic, of their corresponding letter of the Roman alphabet. Uppercase symbols differentiate from the lowercase symbols only slightly, in that uppercase symbols are designated by the simple placement of a dot centrally located above the lowercase symbol frame. Certain essential attributes of the font remain constant while certain measurements, such as the relative spacing and location of the elements of the alphabetic symbols and the line width, change as the font's size is changed. The line width of the alphabetic symbols changes at a different rate than the size of the alphabetic symbols.

In one aspect of the invention, the presentation of the alphabetic symbols can use multiple colors, line widths, or shading.

In still another aspect of the invention, ink printing overlaid on only part of the raised symbols is used to achieve raised letters that are easily read by both the visually impaired and the fully sighted.

In still another aspect of the invention, depending on the font size, the tactile font uses a number of different shaped frames and the interiors of the letters are represented in a number of different ways so that the alphabetic presentations are distinguishable from one another. Alphabetic elements can change in length, angle, spacing, presence and/or line width (proportionate to letter height).

In particular, (1) inter letter spacing changes by a non-constant ratio; (2) line width changes by a non-constant ratio; (3) symbol element ratios changes by a non-constant ratio; (4) symbol element location changes by non-constant ratios; (5) symbol shape changes from font size to font size; (6) symbol elements can be present at some sizes and not present at other sizes or the element sizes can vary in different, non-constant proportions to each other; and at one size, the symbol elements remain fixed or vary based on their location on the computer display screen (i.e., on a computer screen for enlarged text), symbols displayed in the middle of the screen look different than when they are displayed at the side of the screen.

### BRIEF DESCRIPTION OF THE DRAWINGS

FIG. 1 is a table comparing lowercase alphabetic symbols of the Roman alphabet, the prior art ELIA™ font, and first, second, and third embodiments of the dynamic tactile font in accordance with the present invention.

FIG. 2 is a table comparing uppercase alphabetic symbols of the Roman alphabet, the prior art ELIA™ font, and first, second, and third embodiments of the dynamic tactile font in accordance with the present invention.

FIG. 3 is a table comparing numeric symbols of the Arabic numerals, the prior art ELIA™ font, and first, second, and third embodiments of the dynamic tactile font in accordance with the present invention.

FIGS. 4A-4C show the word “alphabet” spelled out in three different sizes of a first embodiment of the dynamic tactile font in accordance with the present invention.

FIG. 5 shows the letter “L” in different sizes in conventional Ariel font.

FIG. 6 shows the symbol for the letter “e” in different sizes in the prior art ELIA™ font.

FIG. 7A shows symbols for the letter “d” in the prior art ELIA™ font and a first embodiment of the dynamic tactile font in accordance with the present invention.

FIG. 7B shows side-by-side symbols for the letter “l” in a first embodiment of the dynamic tactile font in accordance with the present invention, at three different inter-symbol spacings.

FIG. 7C shows symbols for the letters “c” and “v” in the prior art ELIA™ font and a first embodiment of the dynamic tactile font in accordance with the present invention.

### DETAILED DESCRIPTION OF THE INVENTION

All of the alphabetic and numeric symbols of the dynamic tactile font in accordance with the present invention comprise at least a frame. As in the prior art ELIA™ font, the alphabetic symbols of the dynamic tactile font in accordance with the present invention are divided into four regions, the first and third regions having circular frames and the second and fourth regions having square frames, with the frames serving as the primary key to direct the reader to a limited number of candidates, to make deciphering as swift and easy as possible; while the numeric symbols have diamond-shaped frames. Also as in the prior art ELIA™ font, the dynamic tactile font in accordance with the present invention, each of the alphabetic symbols embodies at least a physical association with its corresponding capital letter of the Roman alphabet.

The dynamic tactile font in accordance with the present invention provides three distinct areas of innovation relative to the prior art ELIA™ font: (1) the font in accordance with the present invention is a dynamic font that changes shape according to font size, holding certain essential font attributes constant while varying other essential measurements (line width, spacing and element location) as font size changes; (2) the font in accordance with the present invention effects a redesign of a number of the prior art ELIA™ font's symbols, as well as some basic redesign of the frame shapes and principles behind the prior art ELIA™ font's overall design; and (3) the font in accordance with the present invention contemplates the addition of multiple colors or a clear tactile printing medium such as ink to the use of tactile fonts so that the sighted and visually impaired can both read text printed using the tactile font.

Reading tactilely or with low vision is like reading through frosted glass. The elements of the symbols blur into one another as visual or tactile acuity declines or font size decreases. The innovations implemented by the dynamic tactile font in accordance with the present invention are designed to maximize a person's acuity (tactile or visual) so that he or she can read better in spite of this “frosted glass” effect.

The font in accordance with the present invention is “dynamic” in that the symbol shape, inter-symbol spacing, and symbol line width change in ways that a conventional font's characteristics do not. There are seven such major differences. In the dynamic tactile font in accordance with the present invention:

(1) Inter-symbol spacing changes by a non-constant ratio (as discussed in greater detail hereinafter).

(2) Line width changes by a non-constant ratio (as discussed in greater detail hereinafter).

(3) Symbol element ratios changes by a non-constant ratio (as discussed in greater detail hereinafter).

(4) Symbol element location changes by non-constant ratios (as discussed in greater detail hereinafter).

(5) Symbol shape changes from font size to font size (as discussed in greater detail hereinafter).

(6) Symbol elements can be present at some sizes and not present at other sizes or the element sizes can vary in different, non-constant proportions to each other (as discussed in greater detail hereinafter).

(7) At one size, because the font is “dynamic,” the symbol elements remain fixed or vary based on their location on the computer display screen (i.e., on a computer screen for enlarged text, symbols displayed in the middle of the screen look different than when they are displayed at the side of the screen) (as discussed in greater detail hereinafter).

(1) INTER-SYMBOL SPACING AND SYMBOL PROPORTIONS,

(2) LINE WIDTH, AND (3) SYMBOL ELEMENT SPACING

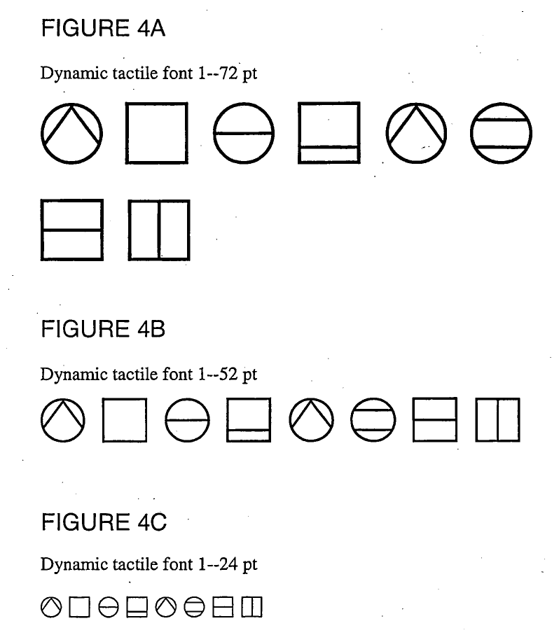

Recognition rates vary widely according to a symbol's line widths (see FIG. 7A), inter-symbol spacing (see FIG. 7B), and element spacing (see FIG. 7C). Conventional fonts in use today have characteristics that scale proportionally (i.e., in a constant ratio) when the symbols are made different sizes. In contrast, in the dynamic tactile font in accordance with the present invention, the inter-symbol spacing changes by a non-constant ratio. For instance, the word “alphabet” in the prior art ELIA™ font, tactile font has inter-symbol spacing and symbol line widths that increase when the font is set at a higher point size. In presently-used variations of the prior art ELIA™ font, as shown in FIG. 4B, at 52 pt, the inter-symbol spacing between the symbols for “l” and “p” in the word “alphabet” is about 4.0 mm and the symbol line width of the “l” is about 0.7 mm. However, as shown in FIG. 4A, at 72 pt, the inter-symbol spacing between the symbols for “l” and “p” in “alphabet” is about 7.0 mm and the symbol line width of the “l” is about 1.0 mm; and as shown in FIG. 4C, at 24 pt, the inter-symbol spacing between the symbols for “l” and “p” is about 2.0 mm and the symbol line width of the “l” is about 0.3 mm. In the dynamic tactile font in accordance with the present invention, these measurements and spacings would remain constant or more constant so that inter-symbol spacing and line width varied only slightly.

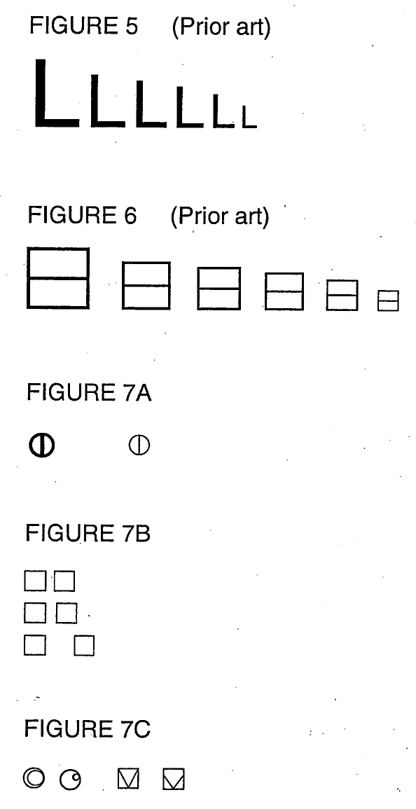

Additionally, in all conventional fonts and in the prior art ELIA™ font, the symbols' proportions (i.e., the ratio of its height to width, feature spacing, and location) remain the same at all font sizes. Taking conventional Arial font as an example, the height of the “L” will always be 164% of its width, as shown in FIG. 5. This type of proportional change works well for fonts used for regular visual reading and for normal print use by sighted individuals. However, with tactile and low vision fonts, the constant line width-to-symbol height ratios inhibit a reader's ability to accurately identify symbols and words because at certain font sizes, symbols become too close together or too far apart and the symbol line width becomes too wide or too narrow to be optimally recognizable.

In conventional fonts and the prior art ELIA™ font, as a font gets smaller or larger, the line width changes in proportion to the height of the font; for example, the symbol for the letter “e” in the prior art ELIA™ font has different line widths at different font sizes (see FIG. 6). Line width has to remain nearly constant as font size is decreased in order to maximize a visually impaired person's ability to distinguish symbols. Similarly, the inter-symbol spacing has to remain relatively constant in order to maximize a person's acuity. If symbols are spaced too closely, recognition rates decline. Presently, as font size declines, inter-symbol spacing decreases proportionally to symbol height. This decrease adversely affects recognition rates. Both line widths and symbol spacing affect tactile and low vision reading in terms of speed and accuracy.

It has been found that the optimal inter-symbol spacing is within the range of about 3.0 mm to about 4.0 mm regardless of font size, and the optimal symbol line widths is within the range of about 0.5 mm and about 1.25 mm.

(4) LETTER ELEMENT LOCATION AND (5) SHAPE CHANGE

I have also found that elements of individual symbols should be spaced differently at different font sizes. For instance, the horizontal line in lines in the symbols for “b” (b), “f” (f) and “h” (h) must be further away proportionally from the outer frame at smaller font sizes than at larger font sizes. In other words, the element spacing and inter-symbol spacing of the font do not change at the same constant rate as the overall size of the frames when the font size is increased and decreased. All of the above features—near constant line width, near constant inter-symbol spacing and near constant symbol element spacing—would result in a font that changes shape.

(6) VARYING LETTER COMPOSITION

At smaller font sizes, certain portions of some symbols may only make differentiation more difficult, for example, the “swirl” in the “s”, the areas of the “z”, “n”, “k”, and “x” where the internal lines meet the frames, and portions of the frames. It therefore may be beneficial to reduce those portions or leave them out of a symbol altogether, according to font size.

The dynamic tactile font can be printed on conventional paper using a commercially-available thermal wax printer such as the Phaser 600 printer sold by Xerox Corporation. The wax can be clear or white, or it can be colored to make text printed using the dynamic tactile font easier to read by sighted and low-vision readers. With a thermal wax printer, it is possible to make each symbol multi-colored, for example, by making the frame component, or a portion of the frame component, one color (for example, white) and the interior component(s) and remaining frame component another color.

A tactile font in accordance with the present invention that is dynamic, i.e. that changes shape as it is reduced in size, is more scalable than conventional fonts, including the prior art ELIA™ font; i.e., readers are able to move more successfully from one font size to another. A scalable font utilizes a person's acuity by spacing and sizing the elements of the symbols and the symbols themselves so that they remained at optimal measurements. For example, one person may correctly identify symbols than are 8 mm high if there is 3.0 mm to 4.0 mm of space around them; however, if there is 2 mm between symbols, the reader's recognition rate declines. Another person may only be able to identify correctly symbols that are at least 12 mm high; however, the inter-symbol spacing should remain in the 3.0 mm to 4.0 mm range. If the symbols were 5.0 cm apart, reading speed and recognition rates would decline.

The design of the symbols in the dynamic tactile font in accordance with the present invention was prompted by the initial study made of the prior art ELIA™ font. In that study, it was found that the best symbols were those for “b”, “e”, “g”, “i”, “l”, “n”, “o”, “p”, “q”, “r”, “t”, “v”, and “z”. They all have a lot of open space and have unique features that tactilely were not commonly confused with other letters. Also, their correct identification is not dependent on a person distinguishing elements in the corners of the frames, as this is very difficult. The symbols of the prior art ELIA™ font that were redesigned to achieve the dynamic tactile font in accordance with the present invention are those symbols that were most commonly confused. The specifics of the changes are as follows:

A—Dropped the bottom bar and gave its two lines the same angle as the symbols for “v” and “k”, as that angle is optimal. A further change that can be made is to open the bottom of the circle slightly so that there is a small gap. This gap is a constant size across font sizes. The gap will help readers differentiate the “a” from the “o”.

C—Reduced the inner circle to be more like a dot and put the circle in the upper right hand portion of the circle. Alternatively, the c can be changed further by making it essentially a Roman “c” but with a specific gap width on the upper right hand side. This gap is a constant size across font sizes.

F—Spaced the interior bar so that it is more easily differentiated from the symbols for “e” and “1”, the two symbols with which it is most confused.

H—Spaced the interior bar so that it is more easily differentiated from the symbols for “e” and “l”, the two symbols with which it is most confused.

J—Moved the tail out of the corner to allow more-room below it, thereby making the interior tail easier to feel.

K—Moved the two interior lines over to the left hand side and anchored the two legs of the symbol for “k” to the left of the right hand corners. This design maximizes interior open space and moves the two legs out of the corners so they can be better recognized. This symbol is more distinguishable. The symbol for “k” was previously confused with the symbols for “t”, “m”, “w”, “v” and “g” because its features blurred with tactile reading to resemble those of the other letters. This same symbol was rotated to use it for the “v”.

M—Used the highly recognizable “g” symbol (rotated). It has more open space and is rarely confused with other symbols. The symbol for “m” had been confused with the symbols for “f”, “e”, and “u”. The “g” symbol (rotated) was also used for the “w” symbol.

Q—Moved the tail's origins down closer to the middle of the bottom.

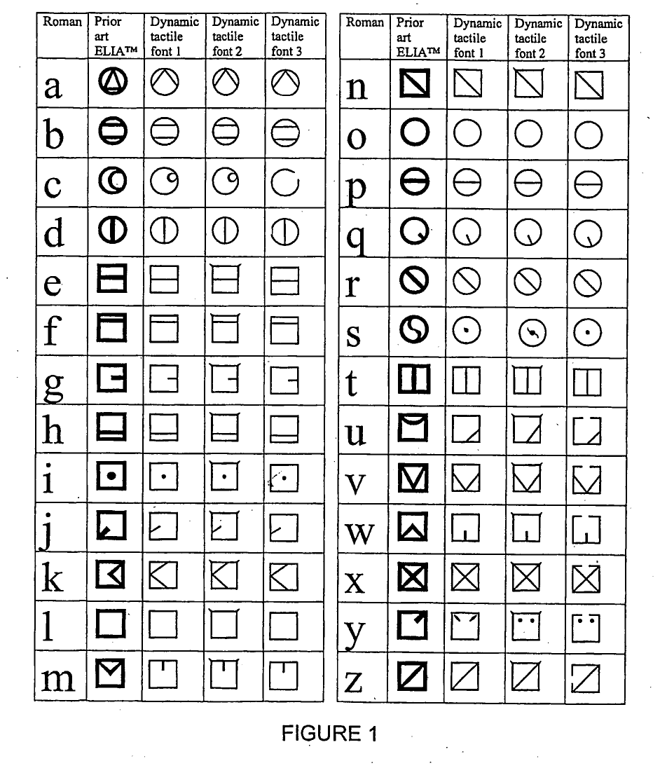

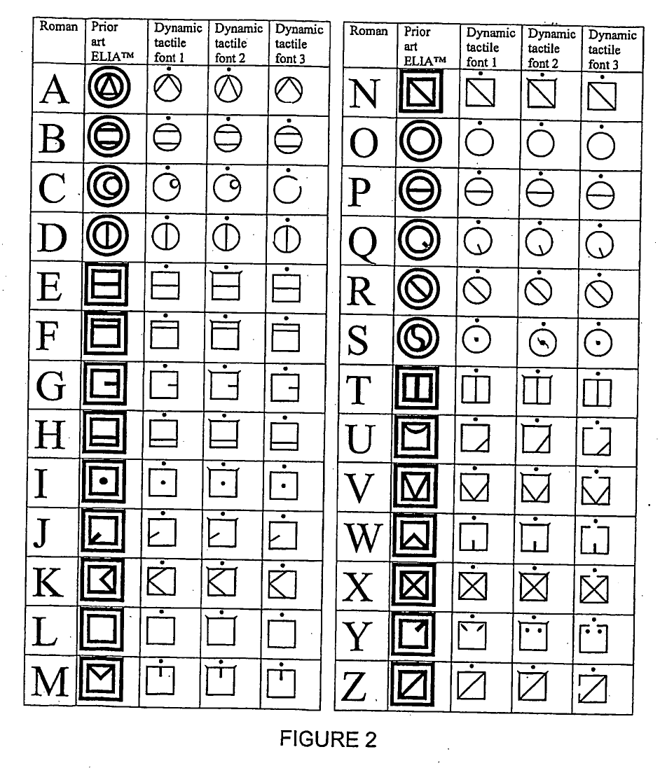

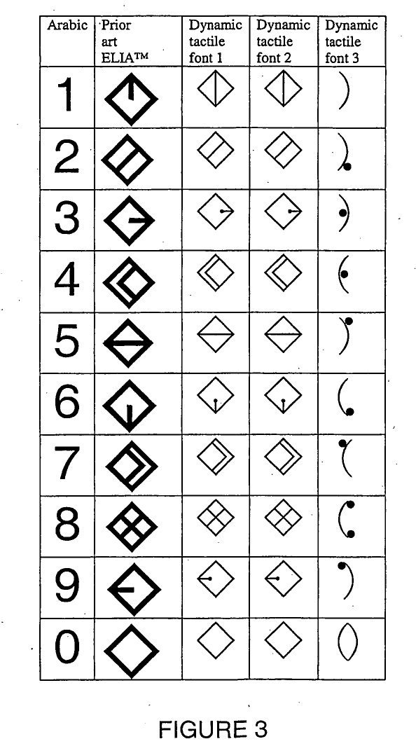

S—Used a dot with two small visual “swirls,” as the “s” symbol of the prior art ELIA™ felt too much like the symbol for “r”. The dot in the middle has two “swirls” to give additional cues that it is not the symbol for “i”. These “swirls” reduce to nearly nothing at smaller font sizes (compare the “s” and “S” symbols of dynamic tactile fonts 1, 2, and 3 in FIGS. 1 and 2).

U—Adjusted the symbol for “u” to be more open and less confusable. It had been confused with the symbols for “f” and “m”. A further change that can be made is to open up a portion of the frame's top middle line (i.e., to place a gap in the frame's top middle line) so that it is not as likely to be confused with the symbol for “1”. The gap in the frame (as with the symbols for “u”-“z”) has a fixed width across font sizes.

V—Moved the interior lines out of the top corners to maximize open space and increase the angle of the interior element and the shape of the interior negative space. A further change that can be made is to open up the top line of the frame, as with the symbol for “u”.

W—Used the highly recognizable “g” symbol (rotated). It has more open space and is rarely confused with other symbols. The symbol for “w” had been confused with the symbols for “h” and “e”. A further change that can be made is to open up the top line of the frame.

X—The symbol for “x” was fairly well recognized because it has so much interior clutter. However, the symbol for “x” can be changed to open the top line of the frame slightly to increase recognition rates.

Y—Have added an additional tail. A further change that can be made is to open up the top line of the frame.

Z—In testing, the symbol for “z” was poorly recognized, possibly because it was rarely used in practice. The symbol for “z” can be changed to open up a small gap in the right or left side of the frame to differentiate it from its most commonly misidentified cousin, the symbol for “n”.

Overall, the general design of the symbols can be changed slightly with respect to the shape of the square frames and in the addition of gaps in the frames. In one embodiment (shown as dynamic tactile font 2 in FIGS. 1 and 2), the shape of the square frames is changed by adding small points to the top corners of the square frames to differentiate them from circles. Frames with this or a similar modification are expected to reduce error rates after 30 hours of study from 14% to 11% (a 21% reduction). In testing, it was more common to misidentify a square as a circle than a circle as a square. It was decided to adjust the square frame for this reason and also because if the circles had been adjusted, the area of the circular letters would have been reduced, which would have adversely affected recognition rates. (see tactile dynamic font 2 in FIGS. 1 and 2).

In another embodiment (shown as dynamic tactile font 3 in FIG. 1), the frames of the symbols for a “b”, “c”, and “d” and for “u”, “v”, “w”, “x”, “y” and “z” are changed to have a portion of their frames removed to create a gap. This-change is expected to help to reduce inter-group errors and should reduce overall errors by an additional 3% (possibly to 8% after 30 hours). The size of the gap remains constant (at about 3 mm to 4 mm) as the font size decreases so that both sides of the gap can be felt at the same time by one finger (see tactile dynamic font 3 in FIGS. 1 and 2).

In all embodiments of the dynamic tactile font, uppercase alphabetic symbols are differentiated from lowercase alphabetic symbols only slightly, by the addition of a dot centrally located above the lowercase symbol frame, as shown in FIG. 2. This differs markedly from the prior art ELIA™ font, in which uppercase alphabetic symbols were denoted by a double frame and lowercase alphabetic symbols were denoted by a single frame.

The dynamic tactile font in accordance with the present invention with frames configured as previously described can be used with tactile reading, tactile printing, and screen reading, especially with hand held devices and low vision reading programs and printed materials.

Conventional fonts require significant manipulation in order to achieve equal inter letter spacing and their symbol line widths change in proportion to the heights of their symbols. The dynamic tactile font in accordance with the present invention offers greater utility in that users do not have to manipulate the font in order to print text that is optimally suited for their needs.

If some portions of the symbols of the dynamic tactile font are not only tactilely identifiable but also printed in clear or white ink, a sighted person can read along faster with visually impaired person. For example the symbol for “n” in the dynamic tactile font is n. If the top and bottom lines of this symbol are printed in clear or white raised ink, the sighted reader would see only an “N”, while the visually impaired reader would feel the full “n” tactile shape. Alternatively, the symbols of the dynamic tactile font can be printed (e.g., using a printer) or displayed (e.g., on a computer monitor) using use a combination of colors to assist low vision readers in learning. This would occur when a low vision reader was reading along using his or her limited vision and was able to make out that the symbol was one or more colors. That patch of color would provide a cue by which he or she could more easily identify the symbol. For example, if the symbols for “a”-“d” were blue and the symbols for “o”-“s” were red, a reader with residual vision could more easily distinguish between the symbols for “d” and “r”.

Modifications and variations of the above-described embodiments of the present invention are possible, as appreciated by those skilled in the art in light of the above teachings. It is therefore to be understood that, within the scope of the above disclosure, the invention may be practiced otherwise than as specifically described.

1. A dynamic font comprising a plurality of alphabetic symbols divided into first, second, third, and fourth regions, the first and third regions having circular frames and the second and fourth regions having square frames, wherein:
each of the alphabetic symbols embodies at least a physical association with its corresponding capital letter of the Roman alphabet;
each of the alphabetic symbols changes shape according to font size, holding certain font attributes constant while varying other font attributes as font size changes.

2. The dynamic font of claim 1, wherein spacing between the alphabetic symbols changes by a non-constant ratio as the font size changes.

3. The dynamic font of claim 1, wherein the line width of the alphabetic symbols changes by a non-constant ratio as the font size changes.

4. The dynamic font of claim 1, wherein at least some of the alphabetic symbols include elements within the frames, and wherein the locations of at least some of the elements of the alphabetic symbols change by non-constant ratios as the font size changes.

5. (canceled)

6. The dynamic font of claim 1, wherein at least some of the alphabetic symbols include elements within the frames at some font sizes but not at other font sizes.

7. The dynamic font of claim 1, wherein at least some of the alphabetic symbols include elements within the frames, and wherein the sizes of the elements can vary in different, non-constant proportions to each other as the font size changes.

8. The dynamic font of claim 1, wherein at least some of the alphabetic symbols include elements within the frames, and wherein at one font size, the location of the elements within the frames depends upon the location of the alphabetic symbol on a display screen.

9. The dynamic font of claim 1, wherein uppercase alphabetic symbols are differentiated from lowercase alphabetic symbols by the present of a dot centrally located above the frames of the lowercase alphabetic symbols.

10. The dynamic font of claim 1, wherein the square frames have small points at the top corners to differentiate them from circular frames.

11. The dynamic font of claim 1, wherein the frames of some of the alphabetic symbols have gaps therein.

12. The dynamic font of claim 1, wherein some portions of the alphabetic symbols are printed in colored ink and other portions are printed in non-colored ink to emphasize the physical association with their corresponding capital letter of the Roman alphabet.

13. The dynamic font of claim 1, wherein the alphabetic symbols are printed or displayed using a combination of colors.

14. The dynamic font of claim 1, wherein the alphabetic symbols are tactile.

15. The dynamic font of claim 1, wherein the alphabetic symbols are embossed on a surface using a tactile printing medium.

16. The dynamic font of claim 1, further comprising a plurality of numeric symbols have diamond-shaped frames.

17. The dynamic font of claim 16, wherein spacing between the alphabetic and numeric symbols changes by a non-constant ratio as the font size changes.

18. The dynamic font of claim 16, wherein the line width of the alphabetic and numeric symbols changes by a non-constant ratio as the font size changes.

19. The dynamic font of claim 16, wherein at least some of the alphabetic and numeric symbols include elements within the frames, and wherein the locations of at least some of the elements of the alphabetic and numeric symbols change by non-constant ratios as the font size changes.

20. The dynamic font of claim 16, wherein the shape of the alphabetic and numeric symbol changes as the font size changes.

21. The dynamic font of claim 16, wherein at least some of the alphabetic symbols include elements within the frames at some font sizes but not at other font sizes.

22. The dynamic font of claim 16, wherein at least some of the alphabetic and numeric symbols include elements within the frames, and wherein the sizes of the elements can vary in different, non-constant proportions to each other as the font size changes.

23. The dynamic font of claim 16, wherein at least some of the alphabetic and numeric symbols include elements within the frames, and wherein at one font size, the location of the elements within the frames depends upon the location of the alphabetic symbol on a display screen.

24. The dynamic font of claim 16, wherein uppercase alphabetic symbols are differentiated from lowercase alphabetic symbols by the presence of a dot centrally located above the frames of the lowercase alphabetic symbols.

25. The dynamic font of claim 16, wherein the square frames have small points at the top corners to differentiate them from eides circular frames.

26. The dynamic font of claim 16, wherein the frames of some of the alphabetic symbols have gaps therein.

27. The dynamic font of claim 16, wherein some portions of the alphabetic and numeric symbols are printed in colored ink and other portions are printed in non-colored ink.

28. The dynamic font of claim 16, wherein the alphabetic and numeric symbols are printed or displayed using a combination of colors.

29. The dynamic font of claim 16, wherein the alphabetic and numeric symbols are tactile.

30. The dynamic font of claim 16, wherein the alphabetic and numeric symbols are embossed on a surface using a tactile printing medium.

31. A process of changing a font, the font comprising a plurality of alphabetic symbols divided into first, second, third and fourth regions, the first and third regions having circular frames and the second and fourth regions having square frames, each of the alphabetic symbols embodying at least a physical association with its corresponding capital letter of the Roman alphabet, the process comprising:
changing the shape of each of the alphabetic symbols according to font size; and
holding certain font attributes constant while varying other font attributes as font size changes.

32. The process of claim 31, further comprising changing spacing between alphabetic symbols by a non-constant ratio as the font size changes.

33. The process of claim 31, further comprising changing a line width of the alphabetic symbols by a non-constant ratio as the font size changes.

34. The process of claim 31, in which at least some of the alphabetic symbols include elements within the frames, and the process comprises changing locations of at least some of the elements of the alphabetic symbols by non-constant ratios as the font size changes.

35. The process of claim 31 in which at least some of the alphabetic symbols include elements within the frames, and the process comprises varying the sizes of the elements in different, non-constant proportions to each other as the font size varies.

36. The process of claim 31 in which at least some of the alphabetic symbols include elements within the frames and, at one font size, the process comprises locating the elements within the frames depending upon the location of the alphabetic symbol on a display screen.

37. The process of claim 31, further comprising printing some portions of the alphabetic symbols in colored ink and printing other portions in non-colored ink, to thereby emphasize the physical association with their corresponding capital letters of the Roman alphabet.

38. The process of claim 31, further comprising printing or displaying the alphabetic symbols using a combination of colors.

39. The process of claim 31, further comprising providing the alphabetic symbols in a tactile form.

40. The process of claim 31, further comprising embossing the alphabetic symbols on a surface using a tactile printing medium.

41. The process of claim 31 in which the font further comprises a plurality of numeric symbols having diamond-shaped frames.

42. The process of claim 41, further comprising changing spacing between the alphabetic and numeric symbols by a non-constant ratio as the font size changes.

43. The process of claim 41, further comprising changing a line width of the alphabetic and numeric symbols by a non-constant ratio as the font size changes.

44. The process of claim 41, wherein at least some of the alphabetic and numeric symbols include elements within the frames, the process further comprising changing locations of at least some of the elements of the alphabetic and numeric symbols by non-constant ratios as the font size changes.

45. The process of claim 41, further comprising changing the shape of the alphabetic and numeric symbols as the font size changes.

46. The process of claim 31, further comprising including elements within the frames of at least some of the alphabetic symbols at some font sizes but not at other font sizes.

47. The process of claim 41, further comprising including elements within the frames of at least some of the alphabetic symbols at some font sizes but not at other font sizes.

48. The process of claim 41 in which at least some of the alphabetic and numeric symbols include elements within the frames, and the process comprises varying the sizes of the elements in different, non-constant proportions to each other as the font size changes.

49. The process of claim 41 in which at least some of the alphabetic and numeric symbols include elements within the frames, and, at one font size, the process comprises locating the elements within the frames depending upon the location of the alphabetic and numeric symbols on a display screen.

50. The process of claim 31, further comprising locating a dot centrally above the frames of lowercase alphabetic symbols to thereby differentiate uppercase alphabetic symbols from lowercase alphabetic symbols.

51. The process of claim 41, further comprising locating a dot centrally above the frames of lowercase alphabetic symbols to thereby differentiate uppercase alphabetic symbols from lowercase alphabetic symbols.

52. The process of claim 31, further comprising providing small points at the top corners of square frames to thereby differentiate them from circular frames.

53. The process of claim 41, further comprising providing small points at the top corners of square frames to thereby differentiate them from circular frames.

54. The process of claim 31, further comprising providing gaps in the frames of some of the alphabetic symbols.

55. The process of claim 41, further comprising printing some portions of the alphabetic and numeric symbols in colored ink and printing other portions in non-colored ink.

56. The process of claim 41, further comprising printing or displaying the alphabetic and numeric symbols using a combination of colors.

57. The process of claim 41, further comprising providing the alphabetic and numeric symbols in a tactile form.

58. The process of claim 41, further comprising embossing the alphabetic and numeric symbols on a surface using a tactile printing medium.
